(19) United States
(12) Patent Application Publication
(10) Pub. No.: US 2026/0363267 A1
(43) Pub. Date: Nov. 19, 2026

(54) System and Method for Making Smores

(71) Applicants: Kyle T. Marshall, Dracut, MA (US); Andre T. Giles, Chelmsford, MA (US)

(72) Inventors: Kyle T. Marshall, Dracut, MA (US); Andre T. Giles, Chelmsford, MA (US)

(21) Appl. No.: 19/669,233

(22) Filed: May 6, 2026

Related U.S. Application Data
(60) Provisional application No. 63/805,845, filed on May 14, 2025.

(51) Int. Cl. A23G 3/54; A23G 1/54; A23G 3/34

(52) U.S. Cl. CPC A23G 3/54; A23G 1/54; A23G 3/0029

(57) ABSTRACT

Systems, methods, and other embodiments for a confectionery treat, including a shell, an optional flavoring layer located on an inside area of the shell, and a cooked marshmallow located over the optional flavoring layer, wherein the cooked marshmallow contacts the optional flavoring layer, melts the optional flavoring layer, and wherein the shell is configured to allow the cooked marshmallow to be retained within the shell but does not allow the cooked marshmallow to be pulled through the shell, thereby causing the marshmallow to melt the optional flavoring layer

### CROSS-REFERENCE TO RELATED APPLICATION

This application claims benefit of U.S. Patent Application No. 63/805,845, filed on May 14, 2025, and claims benefit of U.S. Patent Application No. 63/893,682, filed on Oct. 4, 2025, the disclosures of which are hereby incorporated by reference in their entirety to provide continuity of disclosure to the extent such disclosures are not inconsistent with the disclosure herein.

### FIELD OF THE INVENTION

The present invention relates to a system and method for making confectionery treats called “S'mores”. In particular, the invention is designed to simplify the preparation of a S'more by combining the graham cracker and chocolate together. The product will be in the shape of a mini-S'mores shell that may be made from a graham cracker or other confectionery recipe. The S'mores shell can be in the form of a U-shape, a V-shape, or a pinched end. The S'mores shell may also have a flavoring layer of chocolate or other similar flavoring located on the inside of the shell. The S'mores shell is designed so that the user may slide a cooked (or roasted) marshmallow located on a roasting rod through from one side to the other side of the S'mores shell, stopping the marshmallow, but allowing the rod to pass through, thereby coating the whole inside of the S'mores shell in melted marshmallow and flavoring. The S'mores shell is also designed so that it will hold its shape better than a traditional S'more when eaten. This innovation will prove to be a much simpler and cleaner way to make and eat a S'more than a traditional one.

### BACKGROUND OF THE INVENTION

It is known that traditionally S'mores are confectionery treats that can be made using graham crackers, marshmallows, and chocolate bars. In particular, two graham cracker portions are used to create the S'more. A piece of chocolate bar is placed on one of the graham cracker portions. The marshmallow is cooked or roasted, and the roasted marshmallow is placed on top of the piece of chocolate bar. The other graham cracker portion is placed over the roasted marshmallow so that the roasted marshmallow is retained between the two portions of graham cracker. In this manner, the roasted marshmallow melts the piece of chocolate.

Due to the fact that when the roasted marshmallow contacts the piece of chocolate, both the marshmallow and the piece of chocolate are reduced to a molten mixture of marshmallow and chocolate. This molten mixture is commonly known to ooze out from between the two graham cracker portions and contact the hands of the person who constructed the S'more. This contact between the user's hands and the molten mixture of marshmallow and chocolate can cause minor burning of the hands of the person who constructed the S'more.

Typically, a roasting rod is pushed through the marshmallows, and they are toasted over coals of a campfire by using the roasting rod. It is typically dark and difficult to see. It gets awkward and messy in the dark trying to assemble a S'more.

It is also known that other flavorings, such as dark chocolate, milk chocolate, mint chocolate, candy bars, caramel, or similar products, can be used in conjunction with the roasted marshmallow to create a S'more.

Finally, it is known that if one wants to make a S'more, the person may have to travel to the grocery store and purchase a bag of marshmallows, a bag or bar of flavoring (such as a bar of chocolate or a bag of candy), and a box of graham crackers.

Therefore, it would be desirable to be able to construct a S'more without the possibility of the molten mixture of chocolate and marshmallow coming into contact with the person's hands who is constructing the S'more. Also, it would be desirable to provide a variety of different flavorings that could be used to construct the S'more. Finally, it would be desirable to provide a kit that includes all of the ingredients necessary for constructing a S'more.

This invention's purpose is to fulfill these and other needs in the S'more making art in a manner more apparent to the skilled artisan, once given the following disclosure.

The preferred system and method for making S'mores, according to various embodiments of the present invention, offers the following advantages: ease of use; improved convenience; reduced likelihood of the user's hands coming into contact with the molten mixture of flavoring and marshmallow; and the ability to customize the S'more. In fact, in many of the preferred embodiments, these advantages are optimized to the extent that they are considerably higher than previously achieved in prior known systems and methods for making S'mores.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 is a schematic, top view of a system for making a S'mores shell, constructed according to various embodiments of the present invention described herein.

FIG. 2 is a schematic, top view of the system for making a S'mores shell with a portion of the S'mores shell dough being located within the base, constructed according to various embodiments of the present invention described herein.

FIG. 3 is a schematic, top view of the system for making a S'mores shell with the press being located within the base, constructed according to various embodiments of the present invention described herein.

FIG. 4 is an isometric, top view of a S'mores shell, constructed according to various embodiments of the present invention described herein.

FIG. 5 is an isometric, top view of the S'mores shell, which includes a flavoring layer located on the inside of the S'mores shell, constructed according to various embodiments of the present invention described herein.

FIG. 6 is an isometric, top view of the S'mores shell, which includes a flavoring layer located on the inside of the S'mores shell and a backing area located at one end of the S'mores shell, constructed according to various embodiments of the present invention described herein.

FIG. 7 is an isometric, top view of the S'mores shell, which includes a flavoring layer located on the inside of the S'mores shell, a backing area located at one end of the S'mores shell, and a roasted marshmallow being located on top of the flavoring layer, constructed according to various embodiments of the present invention described herein.

FIG. 8 is an isometric, top view of the S'mores shell, which includes a flavoring layer located on the inside of the S'mores shell, a backing area located at one end of the S'mores shell, and a roasted marshmallow located on top of the flavoring layer after the roasting rod has been removed, constructed according to various embodiments of the present invention described herein.

FIG. 9 is an isometric, front view of the S'mores shell, which includes a flavoring layer located on the inside of the S'mores shell having a V-shaped or pinched end, constructed according to various embodiments of the present invention described herein.

FIG. 10 is an isometric, top view of the S'mores shell having a V-shaped or pinched end, the flavoring layer located on the inside of the S'mores shell, and a roasted marshmallow being located on top of the flavoring layer, constructed according to various embodiments of the present invention described herein.

FIG. 11 is an isometric, top view of the S'mores shell having a V-shaped or pinched end, the flavoring layer located on the inside of the S'mores shell, and a roasted marshmallow being located on top of the flavoring layer after the roasting rod has been removed, constructed according to various embodiments of the present invention described herein.

FIG. 12 is an isometric, top view of a plain, unflavored S'mores shell and a roasted marshmallow being located inside of the plain, unflavored S'mores shell, constructed according to various embodiments of the present invention described herein.

FIG. 13 is an isometric, top view of the plain, unflavored S'mores shell and a roasted marshmallow located inside of the plain, unflavored S'mores shell after the roasting rod has been removed, constructed according to various embodiments of the present invention described herein.

### DETAILED DESCRIPTION OF THE INVENTION

The terminology used herein is to describe particular embodiments only and is not intended to be limiting to the invention. As used herein, the term “and/or” includes any and all combinations of one or more of the associated listed items. As used herein, singular forms “a”, “an”, and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new and unique system and method for making S'mores are discussed herein. In the following description, for purposes of explanation, numerous specific details are set forth to provide a thorough understanding of the present invention. It will be evident, however, to one skilled in the art that the present invention may be practiced without these specific details.

The present disclosure is considered an exemplification of the invention and is not intended to limit the invention to the specific embodiments illustrated by the figures or description below.

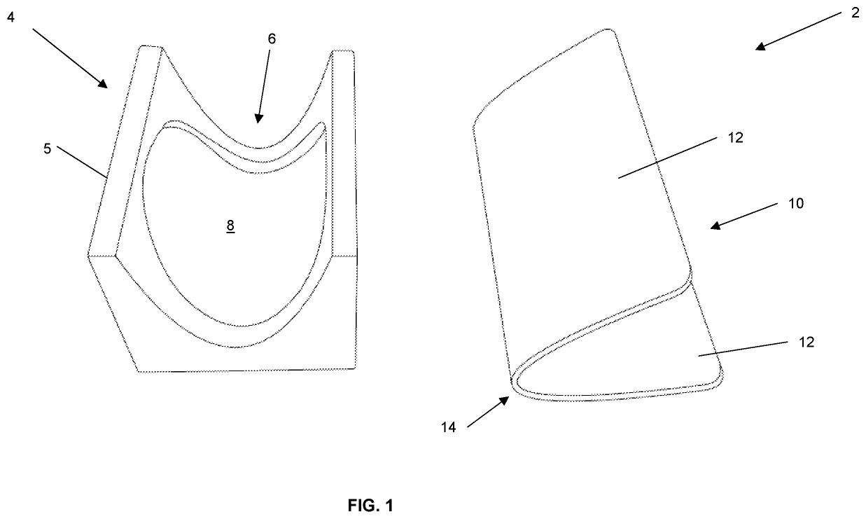

The present invention will now be described by referencing the appended figures representing preferred embodiments. FIGS. 1-11 are illustrations of a system and method of making S'mores.

### Making S'mores Shell 52

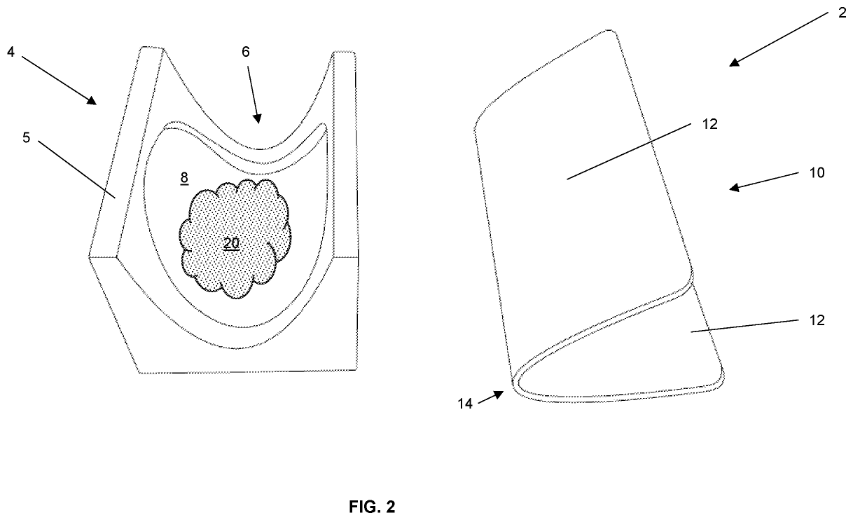

With respect to making the S'mores shell, attention is directed to FIGS. 1-4. In particular, as shown in FIG. 1, there is illustrated S'mores shell making system 2 for use in making S'mores shells 52. In one embodiment, S'mores shell making system 2 includes, in part, base 4 and press 10. Regarding base 4, in one embodiment, base 4 includes, in part, base walls 5, U-shaped base bottom 6, and S'mores shell mold 8. With respect to press 10, in one embodiment, press 10 includes, in part, press walls 12 and U-shaped press bottom 14. It is to be understood that press 10 should be sized and shaped so that press 10 is able to interact with base 4 in order to form S'mores shells 52 from the S'mores shell dough 20 (FIG. 2) when the press 10 is placed within base 4.

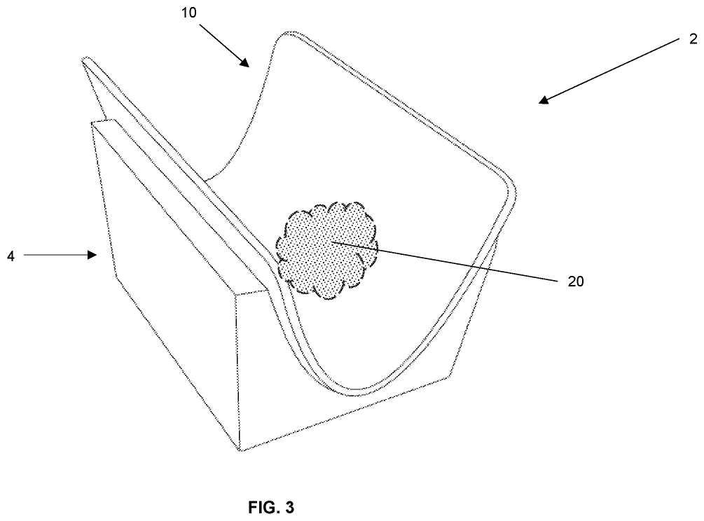

Preferably, base 4 and press 10 are constructed of a durable, heat resistant, rust resistant, lightweight material. Also, S'mores shell mold 8 is formed in base 4 by conventional techniques such as stamping, printing, forming or the like. Furthermore, S'mores shell old 8 should be sized and shaped so as to create a S'mores shell 52 when the portion of S'mores shell dough 20 is placed within base 4 and press 10 is located over S'mores shell dough 20 and pressed onto S'mores shell dough 20 (FIG. 3), as will be discussed in greater detail later. It is to be understood that each S'mores shell assembly 50 includes, in part, a S'mores shell 52 and a flavoring layer 54.

In order to make a S'mores shell 52, a dough 20 is prepared. In one embodiment, the dough 20 can include graham crackers, wheat flour, gluten free flour, or the like. A key aspect of the desired dough 20 being that it must be able to be formed into S'mores shells 52 through the use of base 4 and press 10 and then retain its shape as the S'mores shell assembly 50 is created (such as through conventional baking or deep frying of the S'mores shell 52) and subsequently used to create a S'more.

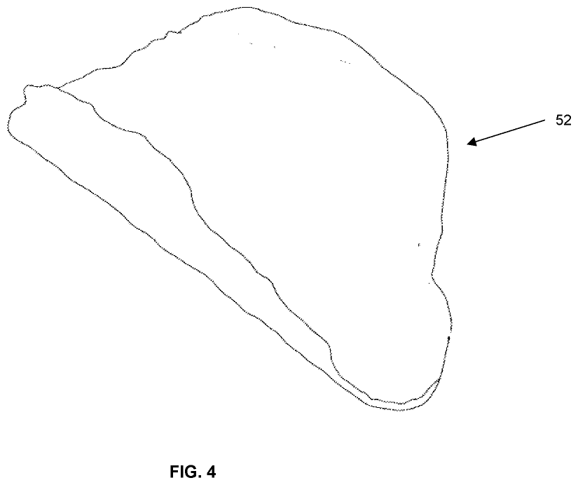

For example, assume that S'mores shells 52 having graham crackers are being made. A dough 20 containing graham crackers and other ingredients such as flour, sugar, butter, leavening agents, and other flavorings such as vanilla is prepared. A desired amount of the dough 20 is then placed in S'mores shell mold 8 (FIG. 2). It is to be understood that the amount of dough 20 can be varied in order to customize the size, thickness, and shape of S'mores shell 52. The dough 20 is then pressed between the base 4 and the press 10 (FIG. 3) to cause the dough 20 to conform to the S'mores shell mold 8 and create a raw S'mores shell. The raw S'mores shell is then conventionally cooked while being located in the base 4 and the press 10. Once the S'mores shell 52 has been cooked to a desired doneness, the cooked S'mores shells 52 are conventionally removed from the base 4 and the press 10 and allowed to cool in order to form a cooled, hardened S'mores shell 52 (FIG. 4).

### Making S'mores Shell Assemblies 50

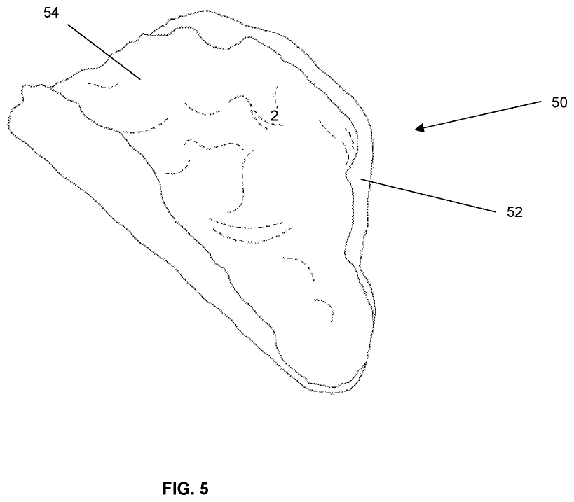

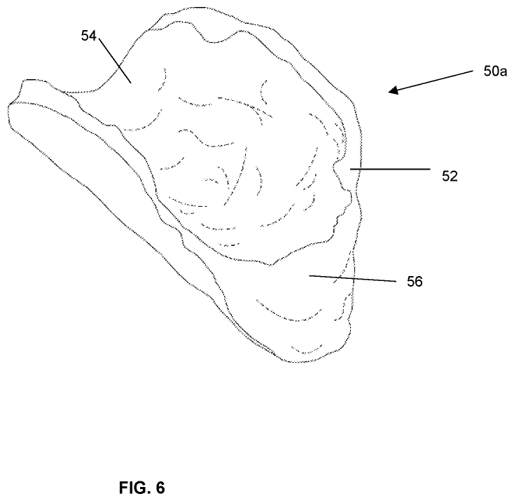

With respect to making the S'mores shell assemblies 50, attention is directed to FIGS. 5 and 6. As shown in FIG. 5, in one embodiment, the S'mores assembly 50 includes, in part, S'mores shell 52 and flavoring layer 54 which could be combined together. In another embodiment, the flavoring layer 54 is located on the inner surface of the S'mores shell 52 as a separate layer.

Regarding flavoring layer 54, in one embodiment, flavoring layer 54 can be created by pouring the flavoring onto the inner surface of the S'mores shell 52 or placing a rolled-out portion of the flavoring layer 54 onto the inner surface of the S'mores shell 52. In particular, a thick slurry of flavoring can be placed on the inner surface of the S'mores shell 52, and the slurry and/or the S'mores shell 52 can be manipulated in order to locate the flavoring layer 54 substantially around the inner surface of the S'mores shell 52.

In another embodiment, the flavoring layer 54 can be prepared so that it has a dough-like consistency that can be rolled out to a desired thickness and size. This flavoring layer 54 of rolled-out flavoring can then be placed on the inner surface of the S'mores shell 52 and lightly pressed onto the inner surface of the S'mores shell 52 to secure the flavoring layer 54 to the inner surface of the S'mores shell 52.

It is to be understood that flavoring layer 54 can also be placed on the inner surface of the S'mores shell 52 by using various techniques such as spraying, coating, depositing, layering, or the like.

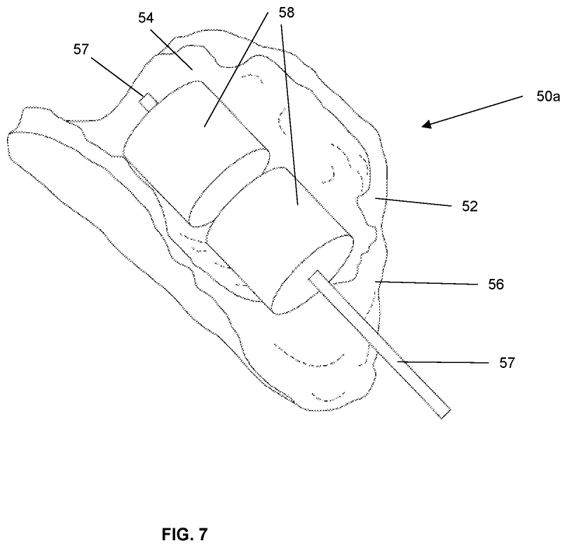

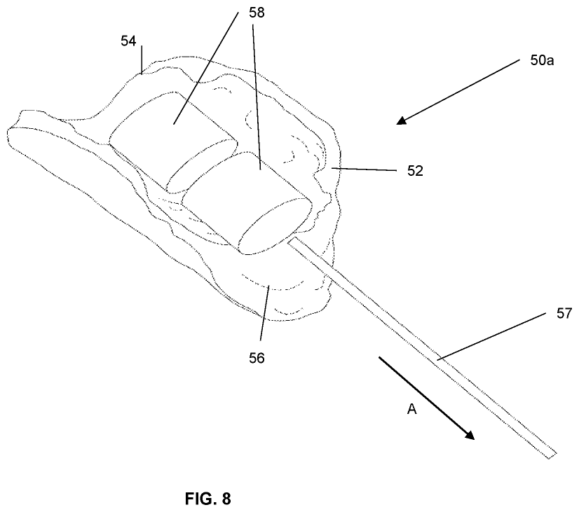

It is to be understood that flavoring layer 54 can be prepared with a variety of flavorings such as dark chocolate, milk chocolate, mint chocolate, candy bars, caramel, fruit flavorings, or the like. A key aspect of the flavoring layer 54 is that it should be capable of melting when the roasted marshmallow 58 (FIGS. 7 and 8) comes into contact with the flavoring area 54. Also, the flavoring layer 54 should be constructed so that it remains in a solid state until the roasted marshmallow 58 comes into contact with the flavoring layer 54.

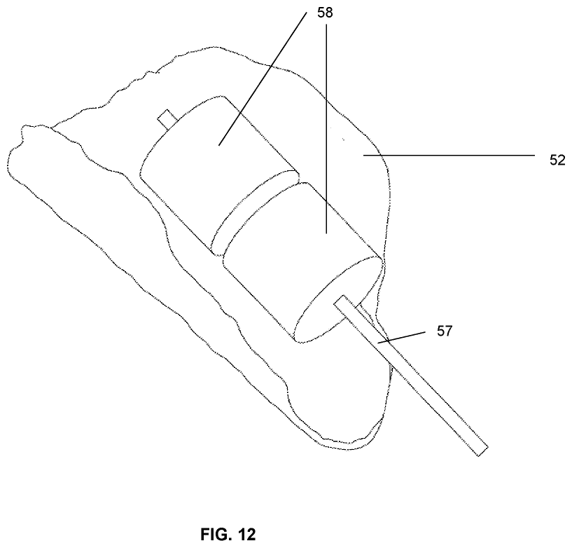

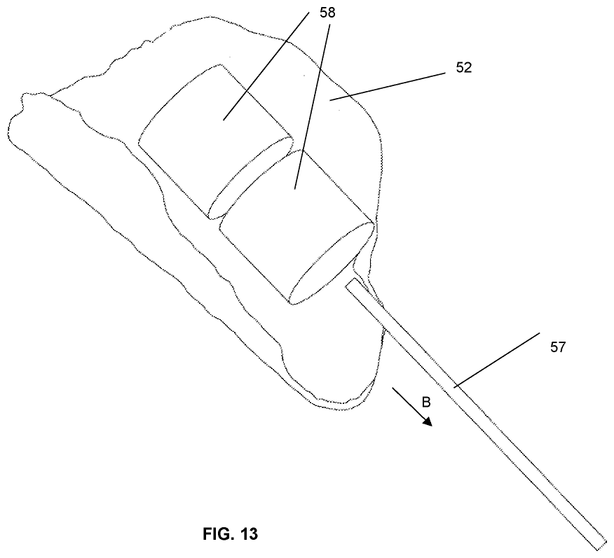

It is to be further understood that a flavoring layer 54 may not have to be added to the S'mores shell 52. As discussed above, the S'mores shell 52 could be combined with a flavoring such as dark chocolate, milk chocolate, mint chocolate, candy bars, caramel, fruit flavorings, or the like. A roasted marshmallow 58 could then be placed within the S'mores shell 52 and retained by the S'mores shell 52. In another embodiment, the S'mores shell 52 without any flavoring layer 54 could be used in conjunction with a cooked marshmallow 56 as shown in FIGS. 12 and 13.

A unique aspect of the present invention is the use of a backing area 56 located on the S'mores shell assembly 50a. In particular, as shown in FIG. 6, there is illustrated another embodiment of a S'mores shell assembly 50a. As shown in FIG. 6, S'mores shell assembly 50a includes, in part, S'mores shell 52, flavoring layer 54, and backing area 56. In this embodiment, a portion of the flavoring layer 54 has been removed and replaced with the backing area 56.

As shown in FIGS. 7 and 8, when the roasted marshmallow 58 on the rod 57 is placed over the flavoring layer 54, and the roasted marshmallow 58 is pulled towards the backing area 56, the backing area 56 prohibits the roasted marshmallow 58 on the rod 57 from being pulled through the S'mores shell assembly 50a (FIG. 7), but allows the rod 57 to be pulled through (FIG. 8) in the direction of arrow A. Consequently, the molten mixture of the melted flavoring layer 54 and the roasted marshmallow 58 should not come into contact with the hands of the person who is constructing the S'more.

### Making the S'mores Shell 152

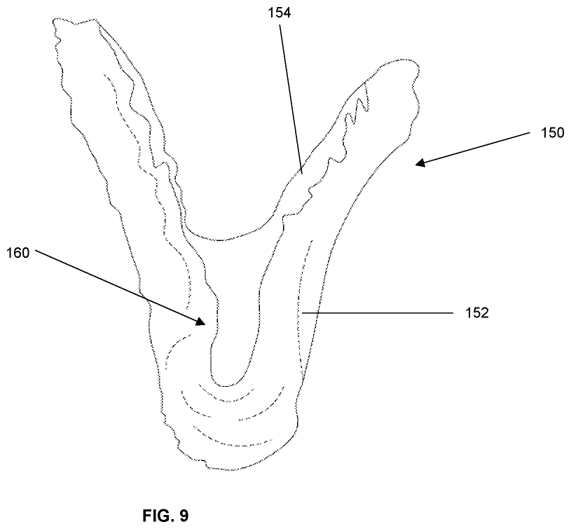

With respect to making the S'mores shell 152 of S'mores shell assembly 150, attention is directed to FIG. 9. It is to be understood that the S'mores shell 152 can be constructed using various techniques such as forming, pressing, molding, cutting, or the like in a similar manner as S'mores shell 52 is constructed. Furthermore, flavoring layer 154 can be placed on the inner surface of the S'mores shell 152 by using various techniques such as spraying, coating, depositing, layering, or the like.

In order to make a S'mores shell 152, a dough is prepared. In one embodiment, the dough can include graham crackers, wheat flour, gluten-free flour, or the like. A key aspect of the desired dough is that it must be able to be retained in the shape of a S'mores shell 152 after the dough has been formed and cooked. It is to be understood that, in one embodiment, base 4 and press 10 can be modified so that a V-shaped S'mores shell 152 (or a S'mores shell 152 having a pinched end) can be created within base 4 and press 10 in a similar manner in which S'mores shell 52 is created.

A unique aspect of S'mores shell 152 is the addition of one V-shaped (or pinched) end 160. It is to be understood that a V-shaped (or pinched) end 160 can be formed on one end of the S'mores shell 152 by techniques such as forming, pressing, molding, cutting, or the like.

### Making S'mores Shell Assemblies 150

With respect to making the S'mores shell assemblies 150, attention is directed to FIG. 9-11. As shown in FIG. 9, in one embodiment, the S'mores assembly 150 includes, in part, S'mores shell 152 and flavoring layer 154 which could be combined together. In another embodiment, the flavoring layer 154 is located on the inner surface of the S'mores shell 152 as a separate layer. In one embodiment, a V-shaped (or pinched) end 160 is formed on one end of the S'mores shell 152.

Regarding flavoring layer 154, in one embodiment, flavoring layer 154 can be created by pouring the flavoring onto the inner surface of the S'mores shell 152 or placing a rolled-out portion of the flavoring layer 154 onto the inner surface of the S'mores shell 152. In particular, a thick slurry of flavoring can be placed on the inner surface of the S'mores shell 152, and the slurry and/or the S'mores shell 152 can be manipulated to locate the flavoring layer 154 substantially around the inner surface of the S'mores shell 152.

In another embodiment, the flavoring layer 154 can be prepared so that it has a dough-like consistency that can be rolled out to a desired thickness and size. This flavoring layer 154 of rolled-out flavoring can then be placed on the inner surface of the S'mores shell 152 and lightly pressed onto the inner surface of the S'mores shell 152 in order to secure the flavoring layer 154 to the inner surface of the S'mores shell 152.

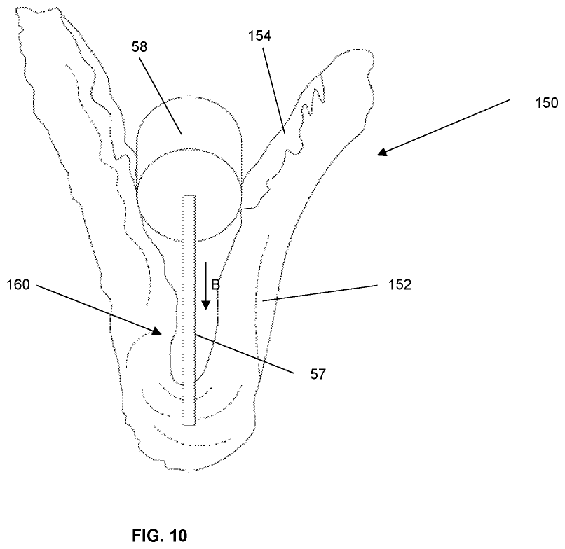

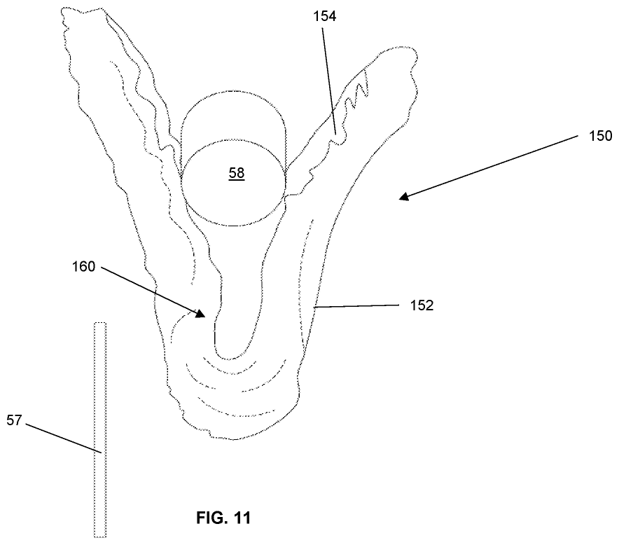

It is to be understood that flavoring layer 154 can be prepared with a variety of flavorings such as dark chocolate, milk chocolate, mint chocolate, candy bars, caramel, fruit flavorings, or the like. A key aspect of flavoring layer 154 being that it should be capable of melting when the roasted marshmallow 58 (FIGS. 10 and 11) comes into contact with flavoring area 154. Additionally, the flavoring layer 154 should be constructed so that it remains in a solid state until the roasted marshmallow 58 comes into contact with it.

As shown in FIGS. 10 and 11, roasted marshmallow 58 located on the rod 57 is placed over the flavoring layer 154. Rod 57 is pulled towards V-shaped (or pinched) end 160 (arrow B in FIG. 10), but the V-shaped (or pinched) end 160 prohibits the roasted marshmallow 58 on the rod 57 from being pulled through the S'mores shell assembly 150. Still, S'mores shell 152 allows rod 57 to be pulled through (FIG. 11). Consequently, the molten mixture of the melted flavoring layer 154 and the roasted marshmallow 58 should not come into contact with the hands of the person who is constructing the S'more.

### Using S'mores Making Equipment System

With respect to using the S'mores making equipment system of the present invention, attention is directed to FIGS. 1-8. In particular, it is determined which kind of S'mores shell 52 will be made. As discussed above, to make a S'mores shell 52, dough 20 is prepared. In one embodiment, the dough 20 can include graham crackers, wheat flour, gluten-free flour, or the like. A key aspect of the desired dough 20 is that it must be able to be formed into a S'mores shell 52 using base 4 and press 10.

For example, assume that S'mores shells 52 having graham crackers are being made. A dough 20 containing graham crackers and other ingredients such as flour, sugar, butter, leavening agents, and other flavorings such as vanilla is prepared. A desired amount of the dough 20 is then conventionally placed into S'mores shell mold 8 of base 4 and pressed with press 10 to a pre-determined size and thickness. After the dough 20 has been pressed with press 10, the base 4, press 10 and dough 20 are placed within a conventional oven or deep fryer in order to cook the dough 20. Once the dough 20 has been cooked to a desired doneness, the base 4, press10, and cooked dough 20 are removed from the conventional oven or deep fryer. The press 10 is removed from the base 4 and the cooked S'mores shell 52 is removed and allowed to cool to form a cooled, hardened S'mores shell 52.

A unique aspect of the present is that instead of the user having to make the S'mores shells 52, a S'mores kit can be constructed that includes pre-made S'mores shells 52. In this instance, the S'mores kit can include S'mores shells 52 made of graham crackers, wheat flour, gluten-free flour, or the like. Furthermore, the S'mores kit can include a base 4 and a press 10, allowing the user to make his/her own S'mores shells 52. Also, the S'mores kit may include a bag or bags of S'mores shell mix similar to a traditional cake mix. In this instance, the user will simply have to provide commonly found household ingredients such as water, oil, eggs or the like to mix with the S'mores shell mix to create the dough necessary for making the S'mores shells 52.

After the S'mores shells 52 have been formed (or removed from the S'mores kit), the user can then select the desired flavoring layer 54. As discussed above, flavoring layer 54 can be created by pouring the flavoring onto the inner surface of the S'mores shell 52 or placing a rolled-out portion of the flavoring layer 54 onto the inner surface of the S'mores shell 52. In particular, a thick slurry of flavoring can be placed on the inner surface of the S'mores shell 52, and the slurry and/or the S'mores shell 52 can be manipulated in order to locate the flavoring layer 54 substantially around the inner surface of the S'mores shell 52.

In another embodiment, the flavoring can be prepared so that it has a dough-like consistency that can be rolled out to a desired thickness and size. This flavoring layer 54 of rolled-out flavoring can then be placed on the inner surface of the S'mores shell 52 and lightly pressed onto the inner surface of the S'mores shell 52 in order to secure the flavoring layer 54 to the inner surface of the S'mores shell 52.

It is to be understood that flavoring layer 54 can be placed on the inner surface of the S'mores shell 52 by using various techniques such as spraying, coating, depositing, layering, or the like.

It is to be understood that flavoring layer 54 can be prepared with a variety of flavorings such as dark chocolate, milk chocolate, mint chocolate, candy bars, caramel, fruit flavorings, or the like. A key aspect of the flavoring layer 54 is that it should be capable of melting when the roasted marshmallow 58 (FIG. 7) comes into contact with the flavoring layer 54. Also, the flavoring layer 54 should be constructed so that it remains in a solid state until the roasted marshmallow 58 comes into contact with the flavoring layer 54.

Another unique aspect of the present is that instead of the user having to make the flavoring layer 54, the S'mores kit can be constructed to include pre-made flavoring layers 54. In this instance, the S'mores kit can include a variety of flavoring layers 54 that are made of dark chocolate, milk chocolate, mint chocolate, candy bars, caramel, fruit flavorings, or the like. Furthermore, the S'mores kit can include a bag or bags of flavoring layer mix similar to a traditional cake mix. In this instance, the user will simply have to provide commonly found household ingredients such as water, oil, eggs, or the like to mix with the flavoring layer mix to create the dough (or slurry) necessary for making the flavoring layer 54. This process will allow the user to customize the S'mores shell assembly 50 or 50a with a desired S'mores shell 52 and/or a desired flavoring layer 54.

Once the user has constructed the S'mores shell assembly 50 or 50a with the desired S'mores shell 52 and/or the desired flavoring layer 54, the user can then conventionally cook or roast the marshmallow 58 by placing the marshmallow 58 onto an end of a roasting rod 57. If the user decides to utilize S'mores shell assembly 50, the roasted marshmallow 58 is placed over the flavoring layer 54, and the roasted marshmallow 58 is pulled towards one end of the S'mores shell assembly 50 in the direction of arrow A (FIG. 8). The user applies a slight pressure on the sides of the S'mores shell assembly 50 to ensure that the roasted marshmallow 58 is retained within the S'mores shell assembly 50 (FIG. 7) and the roasting rod 57 is removed from the roasted marshmallow 58 (FIG. 8). In this manner, the roasted marshmallow 58 then interacts with the flavoring layer 54 to melt the flavoring layer 54.

Once the flavoring layer 54 has been melted to the desired amount, the user can then consume and enjoy the S'mores shell assembly 50 with the roasted marshmallow 58.

A still another unique aspect of the present invention is shown in FIGS. 7 and 8. In particular, as discussed above, when the roasted marshmallow 58 is placed over the flavoring layer 54, and the roasted marshmallow 58 is pulled towards the backing area 56, the backing area 56 prohibits the roasted marshmallow 58 from being pulled through the S'mores shell assembly 50a (FIG. 7) as the roasting rod 58 is removed from the roasted marshmallow 58 (FIG. 8). Consequently, the molten mixture of the melted flavoring layer 54 and the roasted marshmallow 58 should not come into contact with the hands of the person who is constructing the S'more.

Yet another unique aspect of the present invention is the customization of the marshmallow 58. In particular, the S'mores kit can include various flavors of marshmallows 58 so that the end user can further customize the S'mores shell assembly 50 and/or 50a.

With respect to another embodiment of using the S'mores making equipment system of the present invention, attention is directed to FIGS. 9-11. In particular, it is determined which kind of S'mores shell 152 is going to be made. As discussed above; in order to make a S'mores shell 152, a dough is prepared similar to dough 20. In one embodiment, the dough can include graham crackers, wheat flour, gluten-free flour, or the like. A key aspect of the desired dough is that it must be able to be retained in the shape of the shell 152, and the V-shaped (or pinched) end 160 is also retained after the shell 152 is formed and cooked.

For example, assume that S'mores shells 152 with graham crackers are being made. A dough containing graham crackers and other ingredients such as flour, sugar, butter, leavening agents, and other flavorings such as vanilla is prepared. The dough is formed into the desired S'mores shell shape, and the S'mores shell 152 is cooked and cooled, as discussed above.

After the S'mores shells 152 have been formed (or removed from the S'mores kit), the user can then select the desired flavoring layer 154. As discussed above, flavoring layer 154 can be created by pouring the flavoring onto the inner surface of the S'mores shell 152 or placing a rolled-out portion of the flavoring layer 154 onto the inner surface of the S'mores shell 152. In particular, a thick slurry of flavoring can be placed on the inner surface of the S'mores shell 152, and the slurry and/or the S'mores shell 152 can be manipulated to locate the flavoring layer 154 substantially around the inner surface of the S'mores shell 152.

In another embodiment, the flavoring layer 154 can be prepared so that it has a dough-like consistency that can be rolled out to a desired thickness and size. This flavoring layer 154 of rolled-out flavoring can then be placed on the inner surface of the S'mores shell 152 and lightly pressed onto the inner surface of the S'mores shell 152 in order to secure the flavoring layer 154 to the inner surface of the S'mores shell 152.

It is to be understood that flavoring layer 154 can be prepared with a variety of flavorings such as dark chocolate, milk chocolate, mint chocolate, candy bars, caramel, fruit flavorings, or the like. A key aspect of the flavoring layer 154 being that it should be capable of melting when the roasted marshmallow 58 (FIGS. 10 and 11) comes into contact with the flavoring layer 154. Additionally, the flavoring layer 154 should be constructed so that it remains in a solid state until the roasted marshmallow 58 comes into contact with it.

Another unique aspect of the present is that instead of the user having to make the flavoring layer 154, the S'mores kit can be constructed to include pre-made S'mores shells 152 and flavoring layers 154. In this instance, the S'mores kit can include a variety of flavoring layers 154 that are made of dark chocolate, milk chocolate, mint chocolate, candy bars, caramel, fruit flavors, and the like. Furthermore, the S'mores kit may also include a bag or bags of flavoring layer mix similar to a traditional cake mix. In this instance, the user will need to provide commonly found household ingredients, such as water, oil, eggs, or the like, to mix with the flavoring layer mix and create the dough (or slurry) necessary for making the flavoring layer 154. This process will allow the user to customize the S'mores shell assembly 150 with a desired S'mores shell 152 and/or a desired flavoring layer 154.

Once the user has constructed the S'mores shell assembly 150 with the desired S'mores shell 152 and/or the desired flavoring layer 154, the user can then conventionally cook or roast the marshmallow 58 by placing the marshmallow 58 onto an end of a roasting rod 57. If the user decides to utilize S'mores shell assembly 150, the roasted marshmallow 58 is placed over the flavoring layer 154, and the roasted marshmallow 58 is pulled towards the V-shaped (or pinched) end 160 of the S'mores shell assembly 150 (arrow B in FIG. 10). The user applies a slight pressure of the sides of the S'mores shell assembly 150 to ensure that the roasted marshmallow 58 is retained within the S'mores shell assembly 150 (FIG. 10) and the roasting rod 57 is removed from the roasted marshmallow 58 (FIG. 11). The roasted marshmallow 57 is kept from being pulled out of the S'mores shell assembly 150 due the presence of the V-shaped (or pinched) end 160 interacting with the roasted marshmallow 58 (FIG. 11). In this manner, the roasted marshmallow 58 then interacts with the flavoring layer 154 to melt the flavoring layer 154.

Once the flavoring layer 154 has been melted to the desired amount, the user can then consume and enjoy the S'mores shell assembly 150 and the roasted marshmallow 58.

Another unique aspect of the present invention is shown in FIG. 11. In particular, as discussed above, when the roasted marshmallow 58 is placed over the flavoring layer 154. The roasted marshmallow 58 is pulled towards the V-shaped (or pinched) end 160, the V-shaped (or pinched) end 160 prohibits the roasted marshmallow 58 from being pulled through the S'mores shell assembly 150 (FIG. 10) as the roasting rod 57 is removed from the roasted marshmallow 58 (FIG. 11). Consequently, the molten mixture of the melted flavoring layer 154 and the roasted marshmallow 58 should not come into contact with the hands of the person who is constructing the S'more.

Yet another unique aspect of the present invention is the customization of the marshmallow 58. In particular, the S'mores kit can include a variety of different flavors of marshmallows 58 so that the end user can further customize the S'mores shell assembly 50.

In another embodiment, as shown in FIGS. 12 and 13, the S'mores shell 52 without any flavoring layer 54 could be used in conjunction with a cooked marshmallow 56. In particular, if the user decides to utilize S'mores shell 52 that does not include a flavoring layer 54, the roasted marshmallow 58 is placed inside of the unflavored S'mores shell 52, and the roasted marshmallow 58 is pulled towards one end of the unflavored S'mores shell 52 in the direction of arrow A (FIG. 13). The user applies a slight pressure on the sides of the unflavored S'mores shell 52 to ensure that the roasted marshmallow 58 is retained within the unflavored S'mores shell 52 and the roasting rod 57 is removed from the roasted marshmallow 58 (FIG. 13). In this manner, the roasted marshmallow 58 then interacts with the unflavored S'mores shell 52, thereby causing the marshmallow 58 to melt within the shell 52.

While it has not been mentioned, one familiar with the art would realize that the device is not limited by the materials used to create each apparatus that comprise the invention. Any other material type can comprise some or all of the elements in constructing the system and method for making a S'more in various embodiments of the present invention.

Although the present invention has been illustrated and described herein with reference to preferred embodiments and specific examples, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A method of making a confectionery treat, comprising:
making a shell;
making a flavoring layer;
locating the flavoring layer on an inside area of the shell;
cooking a marshmallow on a rod;
placing the cooked marshmallow and rod over the flavoring area; and
pulling the rod and marshmallow through the shell until the cooked marshmallow contacts the flavoring layer, wherein the shell is configured to allow the cooked marshmallow to be retained within the shell but does not allow the cooked marshmallow to be pulled through the shell, thereby causing the marshmallow to melt the flavoring layer.

2. The method, according to claim 1, wherein the making a shell is further comprised of:
preparing a dough;
providing a base, wherein the base comprises;
a plurality of base walls,
a U-shaped base bottom connected to each of the plurality of base walls, and
a shell mold located along portions of the plurality of base walls and the U-shaped base bottom;
providing a press, wherein the press comprises;
a plurality of press walls, and
a U-shaped press bottom connected to each of the plurality of press walls;
placing a portion of the dough into the shell mold;
locating the press over the base and the portion of dough;
pressing the press to cause the portion of dough to conform to the shell mold and create a raw shell;
cooking the raw shell in the base and the press to a desired doneness to create a cooked shell;
removing the cooked shell from the base and the press; and
cooling the cooked shell.

3. The method, according to claim 1, wherein the locating the flavoring layer further comprises:
pouring a flavoring onto the inner surface of the shell.

4. The method, according to claim 1, wherein the locating the flavoring layer further comprises:
placing a rolled-out portion of the flavoring layer onto the inner surface of the shell.

5. The method, according to claim 1, wherein the flavoring layer further comprises:
dark chocolate;
milk chocolate;
mint chocolate;
candy bars;
caramel; or
fruit flavorings.

6. The method, according to claim 1, wherein the shell further comprises:
graham crackers;
wheat flour; or
gluten free flour.

7. The method, according to claim 1, wherein the shell further comprises:
a backing area located on the inside area of the shell and adjacent to an end of the shell and located adjacent to the flavoring layer.

8. The method, according to claim 1, wherein the shell further comprises:
a V-shaped end, wherein the V-shaped end is configured to assist in prohibiting the cooked marshmallow from being pulled through the shell.

9. A confectionery treat, comprising:
a shell;
a flavoring layer located on an inside area of the shell; and
a cooked marshmallow located over the flavoring layer, wherein the cooked marshmallow contacts the flavoring layer, melts the flavoring layer, and wherein the shell is configured to allow the cooked marshmallow to be retained within the shell but does not allow the cooked marshmallow to be pulled through the shell, thereby causing the marshmallow to melt the flavoring layer.

10. The treat, according to claim 9, wherein the shell is further comprised of:
a cooked dough.

11. The treat, according to claim 9, wherein the flavoring layer further comprises:
a poured flavoring layer.

12. The treat, according to claim 9, wherein the flavoring layer further comprises:
a rolled-out portion of the flavoring layer.

13. The treat, according to claim 9, wherein the flavoring layer further comprises:
dark chocolate;
milk chocolate;
mint chocolate;
candy bars;
caramel; or
fruit flavorings.

14. The treat, according to claim 10, wherein the cooked dough further comprises:
graham crackers;
wheat flour; or
gluten free flour.

15. The treat, according to claim 9, wherein the shell further comprises:
a backing area located on the inside area of the shell and adjacent to an end of the shell and located adjacent to the flavoring layer.

16. The treat, according to claim 9, wherein the shell further comprises:
a V-shaped end, wherein the V-shaped end is configured to assist in prohibiting the cooked marshmallow from being pulled through the shell.

17. A confectionery treat, comprising:
a shell; and
a cooked marshmallow located inside of the shell, wherein the cooked marshmallow contacts the shell, and wherein the shell is configured to allow the cooked marshmallow to be retained within the shell but does not allow the cooked marshmallow to be pulled through the shell, thereby causing the marshmallow to melt within the shell.

18. The treat, according to claim 17, wherein the shell is further comprised of:
a cooked dough.

19. The treat, according to claim 18, wherein the cooked dough further comprises:
graham crackers;
wheat flour; or
gluten free flour.
